(19) United States
(12) Patent Application Publication
(10) Pub. No.: US 2019/0061663 A1
(43) Pub. Date: Feb. 28, 2019

(54) METHOD FOR TRANSMITTING INFORMATION FROM MOTOR VEHICLES

(71) Applicant: FORD GLOBAL TECHNOLOGIES, LLC, Dearborn, MI (US)

(72) Inventors: Mohamed BENMIMOUN, Aachen (DE); Muhammad Adeel AWAN, Herzogenrath (DE); Ahmed BENMIMOUN, Aachen (DE)

(73) Assignee: FORD GLOBAL TECHNOLOGIES, LLC, Dearborn, MI (US)

(21) Appl. No.: 16/115,855

(22) Filed: Aug. 29, 2018

(30) Foreign Application Priority Data
Aug. 31, 2017 (DE) 10 2017 215 278.8

(51) Int. Cl. B60R 21/00; G05D 1/10; B60R 21/01; B64C 39/02; G07C 5/00; H04N 7/18; H04W 76/10; H04W 4/40

(52) U.S. Cl. CPC B60R 21/00; G05D 1/101; B60R 21/01; B64C 39/024; G07C 5/008; H04N 7/185; B64C 2201/141; H04W 4/40; B60R 2021/01088; B60R 2021/0027; B64C 2201/127; B64C 2201/208; H04W 76/10

(57) ABSTRACT

Activation of a passive occupant protection system is detected by at least one sensor. Signals indicative of the detection are sent over a communications connection to a telematic unit of the vehicle. Responsive to successful detection of the activation of the occupant protection system, the telematic unit initiates a launch of an accompanying autonomous drone from the vehicle for providing information, the drone autonomously recording aerial images of the vehicle and surroundings of the vehicle using a camera. The aerial images are transmitted to an emergency control center via a mobile communications connection to the emergency control center established by the telematic unit.

### CROSS-REFERENCE TO RELATED APPLICATIONS

This application claims foreign priority benefits under 35 U.S.C. § 119(a)-(d) to DE Application 10 2017 215 278.8 filed Aug. 31, 2017, which is hereby incorporated by reference in its entirety.

### TECHNICAL FIELD

The disclosure concerns a method for transmitting information from motor vehicles with active and/or passive occupant protection systems, wherein there is a telematic unit in the motor vehicle and the telematic unit comprises communications means for establishing a mobile communications connection to an emergency control center, wherein the activation of active and/or passive occupant protection systems is detected by means of at least one sensor, and the relevant signals are transmitted to the telematic unit over a communications connection.

### BACKGROUND

Automatically operating emergency units in motor vehicles are known that analyze the electrical control signal of an airbag. The electrical signal that triggers the airbag triggers an emergency call at the same time that is carried out, for example, by exchanging Short Message Systems, abbreviated to SMS, or by a telephone call to an emergency call center.

From DE 101 55 550 C1, for example a method is known for triggering an emergency call from a vehicle that is equipped with a radio telephone, wherein an emergency call unit with a dedicated battery, with a GSM transceiver and with a transmission and reception unit for establishing a short radio path to the radio telephone is provided in the vehicle and wherein on triggering an emergency call the emergency call unit sends an emergency call over the short radio path to the radio telephone, which forwards the emergency call to an emergency call center by radio.

DE 10 2008 018 868 A1 discloses a method for triggering an emergency call in motor vehicles with active and/or passive occupant protection systems, wherein there is a telematic unit in the motor vehicle and the telematic unit comprises communications means for establishing a mobile communications connection, wherein the activation of active and/or passive occupant protection systems is detected by means of at least one sensor, and the relevant signals are transmitted over a communications connection to a telematic unit and the telematic unit transmits an emergency call following the successful detection of the activation of the active and passive occupant protection systems.

Proprietary systems operate similarly, with which an emergency call is issued automatically following triggering of the airbag for example, wherein the emergency call may contain information about the vehicle and the position thereof and possibly about vehicle systems and is transmitted, so that the emergency call center or emergency control center can initiate rescue measures in a targeted manner.

However, more detailed information would be desirable for the emergency call center or emergency control center, so that the center can initiate more targeted rescue measures.

### SUMMARY

According to the disclosure, it has been recognized that if, following successful detection of the activation of the active and/or passive occupant protection systems, the telematic unit initiates the launch of an accompanying autonomous drone from the motor vehicle for providing information and the drone autonomously records aerial images of the motor vehicle and the surroundings thereof by means of a camera and the aerial images are transmitted to the emergency control center, it is possible to contact the emergency control center not only with the known emergency call, but also to provide an overview for assessing the accident site or the accident.

In an advantageous embodiment, the emergency control center can also carry out the control of the drone. As a result, the drone can be controlled by the emergency control center in a targeted manner to collect further relevant information, which is then transmitted to the emergency control center by the drone.

In this case, it is possible that the telematic unit or the drone transmits the aerial images. For this purpose, the drone is to be equipped accordingly with a cell phone device. It is also conceivable that the telematic unit of the vehicle is disposed in the drone. It is then suitably protected against damage in the event of an accident and can also perform a dual function.

It is purposeful to actively catapult the drone from the motor vehicle into the air when the triggering/activation of the occupant protection system is detected. Thus, on the one hand the drone should already be launched prior to the actual collision, where possible, and on the other hand the probe should be protected against damage by active ejection.

It has been shown to be particularly suitable to combine launching the drone with the successful detection of the activation of at least one airbag.

The drone can fly independently after reaching the minimum flying altitude and can start the aerial photography (and the transmission thereof).

In a preferred version, the drone is housed in an attachment part of the motor vehicle that is equipped with a launcher. Thus, the system can be fitted retrospectively. A roof spoiler is suitable as the attachment part, for example. The launcher can be a catapult or a small airbag that ejects the drone. The airbag has the advantage that the technology is known in the motor vehicle field and is reliable and rapid.

In order to protect the drone against environmental influences, the drone can be accommodated in the attachment part in a covered manner. Said covering must be able to be opened very rapidly. For this purpose, the attachment part can be equipped with a cover that can be opened in a few milliseconds. This can be an actively opened flap or—as in the case of an airbag—a cover that is jettisoned by the airbag. Alternatively, a type of film that will be punched through can also be used.

Further features and details of the disclosure arise from the following description of the drawing. In the figures:

### BRIEF DESCRIPTION OF THE DRAWINGS

FIG. 1 shows a schematic sketch of a passenger vehicle with a drone in a side view and

FIG. 2 shows the passenger vehicle of FIG. 1 with a launched drone.

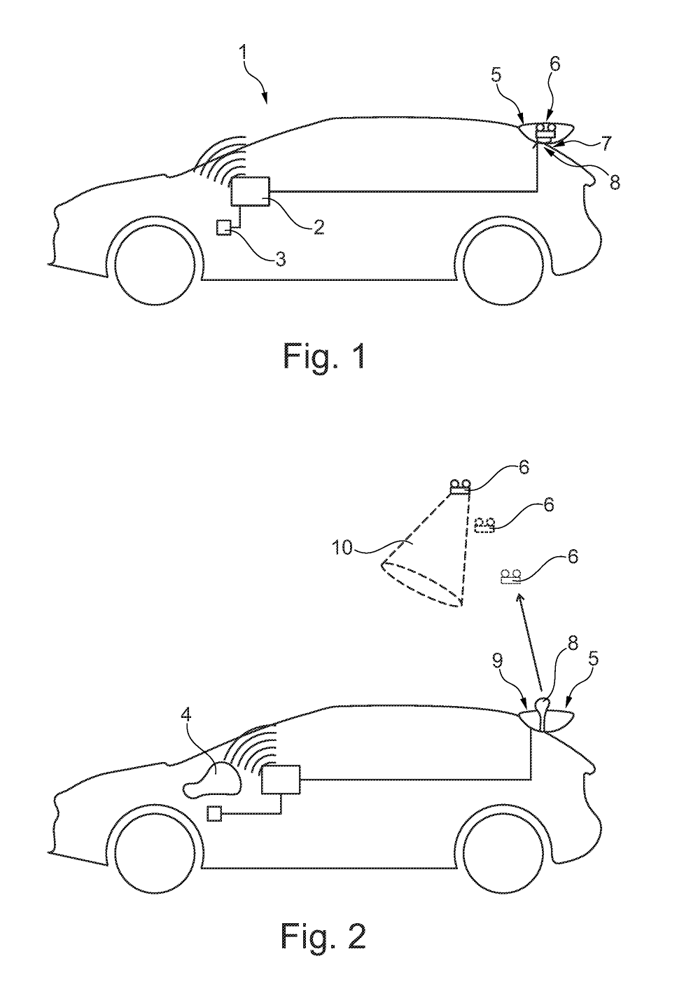

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the figures, a passenger vehicle is shown that is denoted as a whole by 1. The passenger vehicle 1 comprises a telematic unit 2 in known way that monitors the activation of the airbag 4 by means of sensors 3.

The vehicle further comprises a roof spoiler 5 in the rear region, in which a drone 6 that is equipped with a camera is disposed. The drone 6 is disposed in a receptacle with a catapult 7 in the form of an airbag 8 that is controlled by the telematic unit 2.

Thus, the activation of the airbag 4 can be detected by means of the sensor 3 and the related signal can be transmitted to the telematic unit. Following successful detection of the activation of the airbag, the telematic unit initiates the launch of the accompanying autonomous drone 6 to provide information, for which purpose the airbag 8 is triggered. During the launch, the drone 6 punches through a covering film 9.

Thus, the drone 6 is jettisoned from the vehicle. Once the drone has reached a minimum flying altitude, it flies automatically, for which purpose a suitable controller is installed.

The drone 6 then autonomously records aerial images 10 of the motor vehicle and the surroundings thereof by means of the camera and transmits the aerial images to the emergency control center, for which purpose the drone 6 comprises a cell phone unit. Using the cell phone unit, the drone can also be controlled by the emergency control center to determine further information as required, which is then transmitted to the emergency control center.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for transmitting information from a vehicle comprising:
detecting activation of a passive occupant protection system by at least one sensor;
sending signals indicative of the detection over a communications connection to a telematic unit of the vehicle;
responsive to successful detection of the activation of the occupant protection system, initiating, by the telematic unit, a launch of an accompanying autonomous drone from the vehicle for providing information, the drone autonomously recording aerial images of the vehicle and surroundings of the vehicle using a camera; and
transmitting of the aerial images to an emergency control center via a mobile communications connection to the emergency control center established by the telematic unit.

2. The method as claimed in claim 1, wherein the emergency control center carries out control of the drone.

3. The method as claimed in claim 1, wherein the drone is actively catapulted into the air from the vehicle.

4. The method as claimed in claim 1, wherein the drone flies independently after reaching a minimum flying altitude and starts the recording of aerial images.

5. The method as claimed in claim 1, wherein the drone is launched following successful detection of an activation of at least one airbag.

6. The method as claimed in claim 1, wherein the aerial images are transmitted by the telematic unit or by the drone.

7. The method as claimed in claim 1, wherein the drone is housed in an attachment part of the vehicle, which is fitted with a launcher.

8. The method as claimed in claim 7, wherein the attachment part is equipped with a cover that opens in a few milliseconds.

9. The method as claimed in claim 7, wherein the attachment part of the vehicle is a roof spoiler, and the launcher is an airbag.

10. A vehicle comprising:
a telematics unit configured to
responsive to activation of an airbag detected by a signal received from a sensor, launch an autonomous drone from the vehicle for providing information, the drone autonomously recording aerial images of the vehicle and surroundings of the vehicle using a camera; and
transmit the aerial images to an emergency control center via a mobile communications connection to the emergency control center established by the telematic unit.

11. The vehicle as claimed in claim 10, wherein the emergency control center carries out control of the drone.

12. The vehicle as claimed in claim 10, wherein the drone is actively catapulted into the air from the vehicle.

13. The vehicle as claimed in claim 10, wherein the drone flies independently after reaching a minimum flying altitude and starts the recording of aerial images.

14. The vehicle as claimed in claim 10, wherein the drone is launched following successful detection of an activation of at least one airbag.

15. The vehicle as claimed in claim 10, wherein the aerial images are transmitted by the telematic unit or by the drone.

16. The vehicle as claimed in claim 10, wherein the drone is housed in an attachment part of the vehicle, which is fitted with a launcher.

17. The vehicle as claimed in claim 16, wherein the attachment part is equipped with a cover that opens in a few milliseconds.

18. A method comprising:
responsive to activation of an airbag detected by a signal received to a telematic unit, actively catapulting an autonomous drone from a roof spoiler of a vehicle for providing information, the drone autonomously recording aerial images of the vehicle and surroundings of the vehicle using a camera; and
transmit the aerial images to an emergency control center via a mobile communications connection to the emergency control center established by the telematic unit.
